(19) United States
(12) Patent Application Publication
(10) Pub. No.: US 2009/0257889 A1
(43) Pub. Date: Oct. 15, 2009

(54) Vacuum Pump

(76) Inventors: Yongwei Shi, Chiba (JP); Yuji Takahashi, Chiba (JP)

Correspondence Address: Edwards Vacuum, Inc., 2041 MISSION COLLEGE BOULEVARD, SUITE 260, SANTA CLARA, CA, 95054, US

(21) Appl. No.: 12/227,152

(22) PCT Filed: May 14, 2007
(86) PCT No.: PCT/JP2007/059846

§ 371 Date: Mar. 20, 2009

(30) Foreign Application Priority Data
May 19, 2006 (JP) 2006-140186

(51) Int. Cl. F04D 19/04; B23P 15/04

(52) U.S. Cl. 417/244; 29/889.22

(57) ABSTRACT

[Problem to be Solved] Stator blade wheels and rotor blade wheels do not interfere with each other using lower-cost but wider cutting-width cutting or grinding for half-cutting-off of the stator blade wheels and not using expensive but narrower cutting-width wire electric discharge machining.

[Solution] The distance h between a base end face 12ta (12tb) of a stator-blade-wheel outer ring part 12a and the corresponding rotor-blade end face 4aa (4ab), is set at a value larger than the maximum deformation of the running rotor blade wheel 4a during the pump operation. The larger distance h keeps perfectly stator-rotor separation, while the outer ring part 12a of a stator blade wheel 12 goes, in assembling, into the rotor area on account of large shift of any half of stator blade wheels owing to the wide cutting width. It makes also easy stator blade wheel assembling of the pump, as it is allowable to arrange half stator blade wheels with some eccentricity.

### TECHNICAL FIELD

The present invention relates to a vacuum pump and, more particularly, to a vacuum pump having a turbo-molecular pump part.

### BACKGROUND ART

A vacuum pump having a turbo-molecular pump part described in Patent Document 1, for example, is known. Patent Document 1 discloses a vacuum pump which is such that a spacer (50) is interposed between stator blade wheels (11, 11) of upper and lower stages, the spacer (50) is radially positioned by causing an outer circumferential part (50a) of the spacer (50) and an inner circumferential part (1a) of a pump case (1) to abut against each other, a stator blade wheel (11) is radially positioned by causing an outer circumferential part (11a) of the stator blade wheel (11) to abut directly against the inner circumferential part (1a) of the pump case (1) or by causing an outer circumferential part (11a) of the stator blade wheel (11) to abut an abutment part of the spacer (50), which is positioned by abutment against the inner circumferential part (1a) of the pump case (1), and a gap between the stator blade wheels (11, 11) is set at a prescribed distance by use of the spacer (50). The shape of the spacer (50) may be a relatively simple one and cost reduction can be achieved thereby.

The stator blade wheel 11 of Patent Document 1 is such that a plurality of blades that are radially arranged are integrally connected via two inner and outer flanged parts (11-1, 11-2) having the shape of a semicircular arc. There is also a stator blade wheel of another construction without the outer flanged part (11-1). Though not described in Detailed Description, with reference to the drawings, the stator blade wheel (11) has a simple circular disc shape as viewed from the side, and the thickness of the two inner and outer flanged parts (11-1, 11-2) is the same as the thickness of a part where a blade is provided, and the whole provides flat upper and lower surfaces.

In Patent Document 1, because emphasis is laid on the radial positioning of the stator blade wheel (11) and the spacer (50) and the setting of the gap between the stator blade wheels (11, 11) is substantially the same as in conventional techniques, the setting of the gap between the stator blade wheels (11, 11) is not described in detail. However, the setting of the gap between the stator blade wheels (11, 11) is set to ensure that an appropriate gap between a rotor blade wheel (10), which is disposed between the stator blade wheels (11, 11), and the stator blade wheel (11) is appropriately set. And because a plurality of rotor blade wheels (10) and stator blade wheels (11) are alternately superposed, small variations in the thickness of the individual spacers and stator blade wheels and assembling errors accumulate. For this reason, appropriately ensuring all gaps between the rotor blade wheel (10) and the stator blade wheel (11) is an important problem in manufacturing and precise machining of the thickness of the spacers and stator blade wheels and elaborate assembling are required.

Incidentally, as described above, the stator blade wheel (11) is such that a plurality of blades that are radially arranged are integrally connected via the inner flanged part (11-2) having the shape of a semicircular arc or connected also additionally by the outer flanged part (11-1). The part of the radial blade is relatively thin-walled and is apt to be deformed by an external force. Therefore, in the case of a stator blade wheel (11) without the outer flanged part (11-1), deformation is apt to occur due to the pressing between the spacers during pump assembling and it is difficult to ensure that the gap between the stator blade wheels is set at a prescribed value. Although the problem of this deformation is solved by attaching the outer flanged part (11-1), there is a problem in the accuracy in the spacer-abutment face of the outer flanged part. In general, because of its complex shape having a radial blade part, the stator blade wheel is formed by precision casting and the like of an aluminum alloy. The upper and lower spacer-abutment faces of the outer flanged part are rough in the condition as precision cast or as formed by other methods, and the thickness accuracy is not sufficient. Therefore, the function as the spacer abutment face is not fulfilled. For this reason, finish machining by cutting, grinding and the like is further performed to obtain a prescribed thickness and the parallelism of the upper and lower spacer-abutment faces.

Because in Patent Document 1 the setting of the gap between the stator blade wheels is not intended, there is no detailed description thereof and the section of the stator blade wheel in the drawings is drawn in a simple plate-like shape. That is, in Patent Document 1 there is no description of a stator blade wheel in which the spacer-abutment face is easily finish machined. However, in actual stator blade wheels, as shown in FIGS. 8(a), 8(b) and 8(c), there have hitherto been used stator blade wheels suitable for finish machining the upper and lower spacer-abutment faces of the outer flanged part.

FIGS. 8(a), 8(b) and 8(c) show conventional vacuum pumps having stator blade wheels suitable for finish machining the upper and lower spacer-abutment faces of the outer flanged part.

In FIG. 8(a), a plurality of rotor blade wheels 4a integrally formed on an unillustrated rotor and a plurality of stator blade wheels 12 that are provided within a cylinder of a pump case 11 and held in a multi-stage manner by ring spacers 13 with a prescribed gap are alternately arranged with a prescribed gap g1. An outer ring part 12a is present on the outer circumference of the stator blade wheel 12 and upper and lower end faces thereof provide base end faces 12tb, 12ta. The base end faces 12tb, 12ta abut against a lower surface 13f and an upper surface 13e of the ring spacer 13.

The outer ring part 12a is thicker than the blade part of the stator blade wheel 12 by an amount corresponding to a level difference s, which is sufficient for performing finish machining. Thanks to this level difference s, the finish machining of the base end faces 12tb, 12ta can be safely performed without the contact of a finish machining tool with the blade part of the stator blade wheel. In order to ensure a sufficient machining allowance, the level difference s has hitherto been provided by increasing the small gap g1 between the rotor blade wheel 4a and the stator blade wheel 12 further by f, whereby a sufficient machining allowance is ensured without the contact of the tool with the blade part of the stator blade wheel.

By obtaining such a shape, the base end faces 12tb, 12ta are finished with good parallelism by finish machining of the same level as the machining accuracy of the ring spacer 13 and the thickness of the outer ring part 12a is also machined with good accuracy. Owing to the spacer 13 and stator blade wheel 12 with the precisely machined base end faces, the axis line gap g1 between the rotor blade wheel 4a and the stator blade wheel 12 can be set at an appropriate value.

An outer circumferential face 12ac of the outer ring part of the stator blade wheel 12 abuts against an inner cylinder face 11b of the pump case 11 and fixes the radial position of the stator blade wheel 12, as a result of which assembling is performed, the radial gap g2 between the rotor blade wheel 4a and the stator blade wheel 12 is set at an appropriate value.

The smaller the axis line direction gap g1 and radial gap g2 between the rotor blade wheel 4a and the stator blade wheel 12, the better the pump performance. However, an appropriate axis line direction gap g1 and an appropriate radial gap g2 are necessary in order to prevent the rotor blade wheel 4a from being instantaneously deformed during the rotation of the rotor blade wheel 4a due to gas and the like entering the pump and the rotor blade wheel 4a and the stator blade wheel 12 from coming into contact with each other due to machining errors of the rotor blade wheel 4a, stator blade wheel 12 and spacer 13, pump assembling errors and the like.

In a vacuum pump of this kind, as described also in Patent Document 1, the stator blade wheel 12 is divided into two semiannular parts in order to permit pump assembling. The annular stator blade wheel is cut into halves using a tool. As a result of this cutting, the stator blade wheel is ground by a cutting width w that substantially corresponds to the width of the tool and only a linear portion having the cut width w is cut from the circular middle part (see FIG. 3).

On the other hand, in a standard form, each stator blade wheel 12 obtained by combining two semiannular parts abuts snugly against the inner cylinder face 11b of the pump case as shown in FIG. 8(a). However, because a gap corresponding to the cutting width w is present between the two semiannular parts, in the pump assembling process, there is a possibility that due to a radial shift the stator blade wheel 12 departs a little from the inner cylinder face 11b of the pump case, thereby causing problems as shown in FIGS. 8(b) and 8(c).

FIG. 8(b) shows that the stator blade wheel 12 shifts by an amount w′ smaller than the cutting width w, with the result that the rotor blade wheel 4a and the stator-blade-wheel outer ring part 12a approach k′. In this condition, there is a possibility that the outer circumference of the rotor blade wheel 4a and the inner circumference of the stator-blade-wheel outer ring part 12a come into radial contact with each other.

FIG. 8(c) shows that the stator blade wheel 12 shifts by the cutting width w and that the rotor blade wheel 4a and the stator-blade-wheel outer ring part 12a approach each other too much, with the result that a corner of the rotor blade wheel 4a interferes with a corner of the stator-blade-wheel outer ring part 12a by f in the axis line direction and by k in the radial direction, making assembling impossible.

In order to prevent the occurrence of problems as in FIGS. 8(b) and 8(c), it is required that the cutting width w of the stator blade wheel 12 be as small as possible, and the cutting has hitherto been carried out by wire electric discharge machining and the like using a wire that provides a fine cutting width. However, this wire electric discharge machining has the problems that a long machining time is required and that the cost is also high. A practical cutting method that provides a small cutting width w and is efficient has not yet been found.

Patent Document 1: Japanese Patent Laid-Open No. 2003-269364 (scope of claims for patent, paragraph numbers 0021 and 0034, FIG. 2, FIG. 3, FIG. 4)

### DISCLOSURE OF THE INVENTION

### Problems to be Solved by the Invention

The present invention provides a vacuum pump, which solves the above-described problems, and in which stator blade wheels and rotor blade wheels do not interfere with each other using lower-cost but wider cutting-width cutting or grinding for half-cutting-off of the stator blade wheels and not using expensive but narrower cutting-width wire electric discharge machining.

To solve the above-described problems, the vacuum pump of the present invention comprises a cylindrical pump case, a rotor rotatably provided within a cylinder of the pump case, a plurality of rotor blade wheels formed in a multi-stage manner on an outer circumference of the rotor, a plurality of stator blade wheels provided within the cylinder of the pump case and arranged alternately with the rotor blade wheels in a multi-stage manner with a prescribed gap from the rotor blade wheels, and a plurality of ring spacers that are provided within the cylinder of the pump case and are each interposed between the stator blade wheels. Each of the rotor blade wheels is provided with upper and lower rotor-blade end faces, each of the stator blade wheels consists of a pair of cut-off half-annular stator blade wheels and has a blade part and an outer ring part, the blade part is provided with upper and lower stator-blade end faces, each of which facing to a corresponding one of the rotor-blade end faces, the outer ring part is provided with upper and lower base end faces, each of which abutting against a corresponding one of cylindrical abutment end faces of the ring spacers. The distance between the base end face of the outer ring part and a supposed plane which includes the corresponding rotor-blade end face is set at a value larger than the range of deformation of the rotor blade wheel during pump operation.

In the above-described invention, the finish machining of the base end face becomes easy when it is ensured that the base end face of the outer ring part projects from the blade-part end face of the stator blade wheel.

To solve the above-described problems, the method of manufacturing a stator blade wheel of a vacuum pump of the present invention comprises a stator-blade-wheel formation step of forming an annular stator blade wheel having a blade part and an outer ring part, a base end face finishing step of forming a base end face on an end face of the outer ring part, and setting the distance between the base end face of the outer ring part and a supposed plane including the rotor-blade end face corresponding to the base end face at a value larger than the range of deformation of the rotor blade wheel during the operation of a pump when the base end face abuts against a cylinder-abutment end face of a ring spacer of a vacuum pump, and a semiannular shape machining/cutting step of cutting off the stator blade wheel, on which the base end face is formed, into a semiannular shape by machining.

In the present invention, the word “corresponding” in the expression “the rotor-blade end face corresponding to the base end face” means that the blade-part end face of the stator blade wheel on the same side as the base end face (of the stator blade wheel) is opposed to the rotor-blade end face.

In the present invention, the word “distance”, in the expression “the distance between the base end face of the outer ring part and a supposed corresponding plane including the rotor-blade end face”, means the distance h between the base end face 12ta, 12tb and a supposed plane, that includes the rotor-blade end face 4aa, 4ab and is extended to where the base end face 12ta, 12tb faces, i.e., the distance in the direction of the pump axis line.

In the present invention, the phrase “to be set at a value larger than the range of deformation of the rotor blade wheel during the operation of a pump” means to be set at a value larger than the range of deformation in which machining errors of the rotor blade wheel 4a, the stator blade wheel 12 and the spacer 13 and pump assembling errors and the like are added to an experimentally or theoretically estimated amount of deformation if the rotor blade wheel 4a is instantaneously deformed due to gas and the like entering the pump, positional shifts due to machining errors of the rotor blade wheel 4a.

In the present invention, “machining” includes grinding in addition to machining.

### ADVANTAGES OF THE INVENTION

In the present invention, the distance h from the base end face 12ta (12tb) of the stationary-blase outer ring part 12a (see FIG. 5) to a supposed plane including the corresponding base end face 4aa (4ab) is set at a value larger than the range of deformation of the rotor blade wheel 4a during pump operation. Therefore, even in a case where during an assembling process due to a large cutting width w of a stator blade wheel 12, the stator blade wheel 12 shifts radially with respect to a ring spacer 13 and an outer ring part 12a protrudes to a space between the rotor blade wheel 4a and the stator blade wheel 12, there is no possibility that the outer ring part 12a of the stator blade wheel 12 might collide with the rotor blade wheel 4a during operation. Because the outer ring part 12a and the rotor blade wheel 4a do not interfere with each other even when the cutting width w of the stator blade wheel 12 is large, the stator blade wheel 12 can be economically cut into a semiannular shape by cutting using a cutter etc. and grinding without using expensive wire electric discharge machining and besides the pump assembling becomes easy. The pump performance can be maintained.

### BEST MODE FOR CARRYING OUT THE INVENTION

An embodiment of the present invention will be described below with reference to FIG. 1 to FIGS. 7(a), 7(b) and 7(c). FIG. 1 is a longitudinal sectional view showing an embodiment of the present invention. FIGS. 2a and 2b are each partially enlarged sectional views of FIG. 1. FIGS. 3(a) and 3(b) show a stator blade wheel in FIG. 1, FIG. 3(a) being a plan view and FIG. 3(b) being a sectional view. FIG. 4 is a IV-IV enlarged sectional view in FIG. 3(a). FIG. 5 is a sectional view showing a case where the stator blade wheel is set out of setting alignment in FIG. 2(b). FIG. 6 is a partially enlarged sectional view showing another embodiment of the present invention. FIGS. 7(a), 7(b) and 7(c) are explanatory diagrams showing a method manufacturing the stator blade wheel of the present invention.

In FIG. 1, reference numeral 1 denotes a base, reference numeral 2 denotes a stator column, reference numeral 3 denotes a rotor shaft, reference numeral 4 denotes a rotor, reference numeral 5 denotes a radial magnetic bearing, reference numeral 6 denotes an axial magnetic bearing, and reference numeral 7 denotes a motor.

A socket for receiving column 1a is provided in the middle of the above-described base 1. A lower portion of the cylindrical stator column 2 is inserted from the upper side into the socket 1a and fitted thereto and the cylindrical stator column 2 is bolted and provided in a standing manner in the middle of the base 1 on the upper side thereof. The socket 1a is stopped up with a bottom lid 8 attached to a bottom surface of the base 1.

The above-described rotor shaft 3 provides a connection at an upper portion thereof to integrally hold the above-described rotor 4, and is rotatably inserted into an inner cylinder of the stator column 2 while keeping a gap.

That is, between the rotor shaft 3 and the stator column 2 there are disposed the above-described radial magnetic bearing 5 and axial magnetic bearing 6, and in order to ensure that the above-described stator column 2 holds the rotor shaft 3 so as to be rotatable, the radial magnetic bearing 5 radially holds the rotor shaft 3 and the axial magnetic bearing 6 holds the rotor shaft 3 in the axis line direction.

Between the rotor shaft 3 and the stator column 2 there is disposed the above-described motor 7. This motor 7 rotatably drives the rotor shaft 3 and the rotor 4 with respect to the above-described stator column 2.

On an upper outer circumference of the above-described rotor 4, a plurality of rotor blade wheels 4a, 4a, . . . are formed in a multi-stage manner.

There are small gaps between the two magnetic bearings 5, 6 and a member on the stator column 2 side and a member on the rotor shaft 3 side of the motor 7. The control of each gap of the magnetic bearings 5, 6 enables the rotor shaft 3 and the rotor 4 to be stably held in the space, and the rotor shaft 3 and the rotor 4 are rotated at high speeds by the motor 7.

Reference numeral 11 denotes a pump case, reference numeral 12, 12, . . . denotes a plurality of stator blade wheels, and reference numeral 13, 13, . . . denotes a plurality of ring spacers.

The above-described pump case 11, which is cylindrical, is attached above the above-described base 1. The pump case 11 houses the stator column 2 within the cylinder thereof and houses the rotor shaft 3 and the rotor 4 so as to be rotatable.

The above-described stator blade wheels 12, 12, . . . are superposed alternately with the plurality of rotor blade wheels 4a, 4a, . . . of the above-described rotor 4 with a prescribed gap kept, and a turbo-molecular pump part is formed by the rotor blade wheels 4a, 4a, . . . and the stator blade wheels 12, 12, . . . .

The above-described ring spacers 13, 13, . . . are axially provided in a superimposed manner in the upper portion within the cylinder of the above-described pump case 11 and are each interposed between the above-described stator blade wheels 12, 12.

Reference numeral 14 denotes a screw stator that is provided on an inner surface of the pump case 11 between the base 1 and the above-described stator blade wheels 12, 12, . . . and a screw groove 14a is formed on an inner circumferential face of the screw stator 14. The screw groove 14a of this screw stator 14 faces an outer circumferential face of a thin-walled, cylindrical skirt part 4b of a lower portion of the above-described rotor 4 in proximity to the outer circumferential face and a crew-groove pump part is formed by the screw groove 14a and the skirt part 4b.

Reference numeral 15 denotes a suction port of the pump and reference numeral 16 denotes an exhaust port. The suction port 15 is provided in an upper portion of the pump and the exhaust port 16 is provided within the base 1.

Reference numeral 18 denotes a protective bearing provided between the stator column 2 and the rotor shaft 3. This protective bearing 18 is intended for preventing the contact between the magnetic bearings 5, 6 and each stator column side and rotor shaft side of the motor 7 when it is impossible to control the magnetic bearings in the case of power failures, circuit abnormalities and the like.

Next, details of the turbo-molecular pump part, which is one of the features of the present invention, will be described with reference to FIGS. 2(a) and 2(b) to FIGS. 7(a), 7(b) and 7(c).

In FIG. 2(a), rotor-blade end faces 4aa, 4ab are formed on upper and lower surfaces of the above-described rotor blade wheel 4a. The above-described rotor-blade end faces 4aa (4ab) provides a supposed plane orthogonal to a rotor axis line that envelopes top surfaces (bottom surfaces) of a plurality of radial blades (not shown) formed in the rotor blade wheel 4a. A blade-part end face 12ya (12yb) of the stator blade wheel provides a supposed plane orthogonal to a rotor axis line that envelopes top surfaces (bottom surfaces) of a plurality of radial blades 12w, 12w, . . . (see FIGS. 3 and 4) formed in the blade part 12b of the stator blade wheel.

In this embodiment, the ring spacer 13 has an inner cylindrical face 13a, an outer cylindrical face 13b, a 2^{nd} inner cylindrical face 13c, a stepped outer cylindrical part 13d, an upper cylinder-abutment end face 13e, and a middle cylinder-abutment end face 13f. The 2^{nd} inner cylindrical face 13c limits the stator-blade-wheel radial shift, which would be caused by the cutting width w.

The above-described inner cylindrical face 13a is formed in the upper part of the spacer, and the outer cylindrical face 13b is formed on substantially the whole outer circumference of the spacer in the rotor axis direction. The 2nd inner cylindrical face 13c, which provides a diameter intermediate between diameters of the inner cylindrical face 13a and the outer cylindrical face 13b, is formed in the lower portion of the spacer, and the stepped outer cylindrical part 13d, which provides a diameter intermediate between the diameters of the inner cylindrical face 13a and the outer cylindrical face 13b, is formed in the upper portion of the spacer so as to engage with the 2^{nd} inner cylindrical face 13c of the ring spacer 13, which is adjacent above. The inner cylindrical face 13a, the outer cylindrical face 13b, the 2^{nd} inner cylindrical face 13c, and the stepped outer cylindrical part 13d are formed concentrically with each other.

The above-described upper cylinder-abutment end face 13e connects, at the highest top end of the spacer, the inner cylindrical face 13a and the stepped outer cylindrical part 13d together, and provides a cylinder-abutment end face that abuts against a lower-side base end face 12ta of the stator blade wheel 12, which is adjacent above. The above-described middle cylinder-abutment end face 13f connects the inner cylindrical face 13a and the 2^{nd} inner cylindrical face 13c together, and provides a cylinder-abutment end face that abuts against an upper-side base end face 12ta of the stator blade wheel 12, which is adjacent below.

The stator blade wheel 12 is such that an outer circumferential face 12ac of the outer ring part 12a thereof is fitted onto the 2^{nd} inner cylindrical face 13c, and the upper and lower base end faces 12tb, 12ta of the outer ring part 12a abut against the cylinder-abutment end faces 13f, 13e, respectively, as described above, and are fixed by being vertically sandwiched by the ring spacer 13. In this condition, the blade part 12b of the stator blade wheel 12 is positioned between the rotor blade wheels 4a, 4a above and below the blade part 12b.

Next, a description will be given of a rotor axis line direction and radial direction positioning mechanism of the plurality of stator blade wheels 12, 12, . . . and ring spacers 13, 13, . . . with reference to FIGS. 2(a) and 2(b).

In this embodiment, the upper cylinder-abutment end face 13e of a topmost spacer 13(T) abuts against a spacer-abutment end face 11a provided in an upper portion of the inner cylinder of the pump case 11 (FIG. 2(a)), and the lower-side base end face 12ta of a bottommost stator blade wheel 12(B) abuts against a stator blade wheel abutment end face 14b provided on an upper surface of the screw stator 14 (FIG. 2(b)). In pump assembling, with the stator blade wheels 12, 12, . . . and the ring spacers 13, 13, . . . on the screw stator alternately stacked, the pump case 11 is placed from above and the pump case 11 is fastened to the base 1 with a bolt 19 (see FIG. 1), whereby the positioning of all of the stator blade wheels 12, 12, . . . in the rotor axis line direction is performed and the gap between each stator blade wheel 12 and rotor blade wheel 4a, i.e., the distance between a blade-part end face 12ya (12yb) of the stator blade wheel and the rotor-blade end face 4ab (4aa), which are opposed to each other, is set at a prescribed value g1.

The stepped outer cylindrical part 13d of the topmost spacer 13(T) is fitted onto the spacer-abutment cylindrical face 11c adjacent to the above-described spacer-abutment end face 11a, and the outer circumferential face 12ac of the bottommost stator blade wheel 12(B) and the spacer-abutment cylindrical face 14c adjacent to the above-described stator blade wheel abutment end face 14b are fitted onto the 2^{nd} inner cylindrical face 13c of the bottommost ring spacer 13(B). Furthermore, because the plurality of ring spacers 13, 13 . . . , which are vertically superposed, engage with each other at the 2^{nd} inner cylindrical face 13c and the stepped outer cylindrical part 13d, the positioning of all of the stator blade wheels 12, 12, . . . and ring spacers 13, 13, . . . in the rotor radial direction is performed. As a result of this, the radial gap g2 between the rotor blade wheel 4a of the rotor 4 and the ring spacer 13 is set.

A more detailed description of the stator blade wheel 12 will be given below with reference to FIGS. 3(a) and 3(b) and FIG. 4.

As shown in FIGS. 3(a) and 3(b), the above-described stator blade wheel 12 has an inner ring part 12c in addition to the above-described outer ring part 12a and blade part 12b.

As already described, the above-described outer ring part 12a has, on an upper surface and a lower surface thereof, the base end faces 12ta, 12tb that abut against the cylinder-abutment faces 13e, 13f of the ring spacer 13, and the above-described blade part 12b is provided with a plurality of radial blades 12w, 12w, 12w . . . . As shown in FIG. 4, the blade 12w has a twisted section, and when the rotor 4 having a blade twisted in the direction opposite to the blade 12w rotates, it is ensured that the two blades cause gas molecules to move to below the pump.

Forward ends of these blades 12w, 12w, 12w . . . are connected to the outer ring part 12a and base ends thereof are connected to the inner ring part 12c. The outer ring part 12a and the inner ring part 12c determine the arrangement of each of the blades 12w and strongly hold the blades 12w, thereby preventing the deformation of the blades 12w during the entry of the air. Incidentally, it is not always necessary that the inner ring part 12c be provided, though in this case the holding strength of the blades 12w decreases a little.

Incidentally, in the structure of a vacuum pump of the present invention, the above-described stator blade wheel 12 is formed by combining two semiannular stator blade wheels, which have been cut, into an annular shape. The reason why the annular stator blade wheel 12 is divided into two semiannular stator blade wheels is that the rotor blade wheels 4a, 4a . . . , which are disposed in a superimposed manner alternately with the stator blade wheels 12, 12 . . . , are formed integrally with the rotor 4 and hence it is impossible to assemble a pump, with the stator blade wheel 12 kept in an annular condition. Therefore, the stator blade wheel 12 is cut into semiannular stator blade wheels 12H, 12H as shown in FIG. 3, and in the pump assembling process the semiannular stator blade wheels 12H, 12H are inserted opposite to each other between rotor blade wheels 4a, 4a and then combined into the shape of the annular stator blade wheel 12.

When the stator blade wheel 12 has been cut, the stator blade wheel 12 becomes two semiannular stator blade wheels 12H, 12H after the cutting-away of the stator blade wheel 12 by a cutting width w corresponding to the width of the cutting tool. The stator blade wheel 12 that is brought back to the initial condition by causing the semiannular stator blade wheels 12H, 12H, from which a portion corresponding to the cutting width w has been cut away, to face each other, and this stator blade wheel 12 does not provide a complete annular shape. Therefore, the stator blade wheel 12 sandwiched by the ring spacers 13, 13 in the assembling process is such that as indicated by alternate long and two short dashes lines of FIG. 5, the outer circumferential face 12ac may sometimes abut against the 2^{nd} inner cylindrical face 13c of the ring spacers 13 or conversely, the stator blade wheel 12 is caused to approach the opposite side in the radial direction and as indicated by solid lines, the 2^{nd} inner cylindrical face 13c and the outer circumferential face 12ac may sometimes depart from each other by w. Also the positions of the above-described two members may sometimes be intermediate between the positions of the two cases. That is, the outer ring part 12a may sometimes protrude to the rotor blade wheel 4a side.

Therefore, when the level difference s between the blade-part end face 12ya (12yb) of the stator blade wheel and the base end face 12tb (12ta) is larger than the axis-line direction gap g1 between the rotor blade wheel 4a and the stator blade wheel 12 or when the outer ring part 12a protrudes into the range of deformation of the rotor blade wheel 4a during pump operation even if this level difference s is smaller than g1, there is a possibility that the outer ring part 12a may interfere with the rotor blade wheel 4a.

Therefore, in the present invention, the level difference s is reduced, whereby the distance h from the base end face 12ta (12tb) of the outer ring part 12a to a supposed plane including the rotor-blade end face 4aa (4ab) corresponding to the base end face is set at a value larger than the range of deformation of the rotor blade wheel 4a during pump operation. If this is done, even in the case where the position of the semiannular stator blade wheel 12H shifts to a leftmost position of FIG. 5 by w, a space corresponding to the height h is ensured between the base end face 12ta (12tb) and the rotor-blade end face 4aa (4ab), and the rotor blade wheel 4a does not interfere with the outer ring part 12a of the stator blade wheel 12a even when the rotor blade wheel 4a is deformed during pump operation.

From the standpoint of the manufacturing of the stator blade wheel 12, if the base end face 12ta (12tb) of the outer ring part 12a protrudes from the blade-part end face 12yb (12ya) of the stator blade wheel, then during the finish machining of the base end face 12ta (12tb) there is a possibility that the tool may come into contact with the blade 12w of the stator blade wheel, and this is undesirable.

However, the present invention is not limited to the example of FIG. 5, and as shown in FIG. 6, the base end face 12ta (12tb) of the outer ring part 12a may be depressed by r compared to the blade-part end face 12yb (12ya) of the stator blade wheel. In this case, when the base end face 12ta (12tb) is finish machined, in order to prevent a mounting bed of the stator blade wheel and a tool form coming into contact with the blade 12w of the stator blade wheel, it is advisable to provide a draft clearance for the blade part 12b of the stator blade wheel in the mounting bed or to perform finish machining so that the tool avoids the blade part 12b of the stator blade wheel.

The manufacturing of the stator blade wheel 12 is performed by the steps of FIGS. 7(a) to 7(c).

First in step (a), a stator-blade-wheel material 12 is formed by precision casting and the like; the stator-blade-wheel material 12 has the shape of a disk, a plurality of radial blades 12w, 12w, . . . are formed in a blade part 12b, an inner ring part 12c is formed on the inner side of the blade part 12b, and an outer ring part 12a is formed on the outer side. In this embodiment, the outer ring part 12a is such that the outer ring part 12a is thicker than the blade part 12b and the inner ring part 12c, and a machining allowance for finish machining is provided on both end faces 12ta, 12tb.

Next in step (b), the stator-blade-wheel material 12 is mounted, with one of the two end faces 12ta, 12tb applied to a base plane of a mounting bed for base end face finishing (not shown), and the other end face 12ta (12tb) is finished by lathe turning. The level difference s (see FIG. 5) between the end face 12ta (12tb) and a blade-part end face 12yb (12ya) of the stator blade wheel is adjusted to a design value. After that, the stator-blade-wheel material 12 is turned back and with the end face that has become a base end face by finishing applied to the base plane of the mounting bed for base end face finishing, the stator-blade-wheel material 12 is mounted and the other face is similarly finished. The thickness of the outer ring part 12a is adjusted to a design value and the level difference s between the two faces is finished to s. Because due to machining errors of the above-described step (a), the level difference between the two is not always accurately adjusted. However, this is permissible because small errors are taken into consideration in the value of the above-described distance h. The thickness of the outer ring part 12a is adjusted to a design value as precisely as possible, because errors of the thickness of the outer ring part 12a accumulate during assembling.

Lastly in step (c), the stator blade wheel 12 is mounted, with one of the base end faces 12ta (12tb) of the outer ring part 12a finished in (b) aligned with a mounting bed for cutting (not shown), and the stator blade wheel 12 is cut into two semiannular stator blade wheels 12H, 12H by using a cutter for cutting. The cutting width w is substantially equal to the width of the cutter for cutting and is larger than a conventional cutting width obtained by use of wire electric discharge machining. In the present invention, however, the distance h, between the base end face 12ta (12tb) of the outer ring part 12a and a supposed corresponding plane including the rotor-blade end face 4aa (4ab), is set at a value larger than the range of deformation of the rotor blade wheel 4a during pump operation. Therefore, even when the semiannular stator blade wheel 12H shifts radially during assembling, the rotor blade wheel 4a does not interfere with the outer ring part 12a of the stator blade wheel and the pump function is impaired in no way. In addition, the cutting tool is inexpensive, the cutting time is short, and this is very economical.

In step (c) above, in addition to the cutter for cutting, a grinding wheel, such as a diamond wheel, a CBN wheel and a resin bond wheel, may also be used.

### BRIEF DESCRIPTION OF THE DRAWINGS

FIG. 1 is a longitudinal sectional view showing an embodiment of the present invention;

FIGS. 2(a) and 2(b) are each partially enlarged sectional views of FIG. 1;

FIGS. 3(a) and 3(b) show a stator blade wheel in FIG. 1, FIG. 3(a) being a plan view and FIG. 3(b) being a sectional view;

FIG. 4 is a IV-IV enlarged sectional view in FIG. 3(a);

FIG. 5 is a sectional view showing a case where the stator blade wheel is set out of setting alignment in FIG. 2(b);

FIG. 6 is a partially enlarged sectional view showing another embodiment of the present invention;

FIGS. 7(a), 7(b) and 7(c) are explanatory diagrams showing a method manufacturing the stator blade wheel of the present invention; and

FIGS. 8(a), 8(b) and 8(c) are explanatory diagrams to explain problems in conventional vacuum pumps.

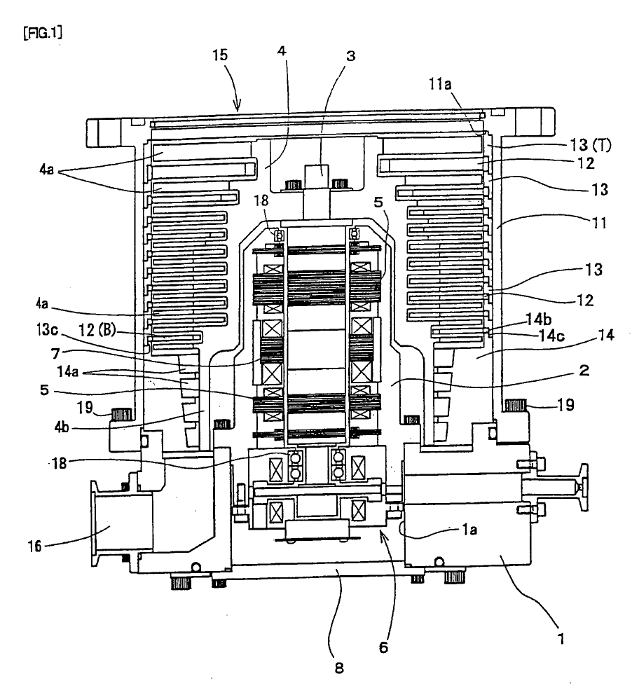

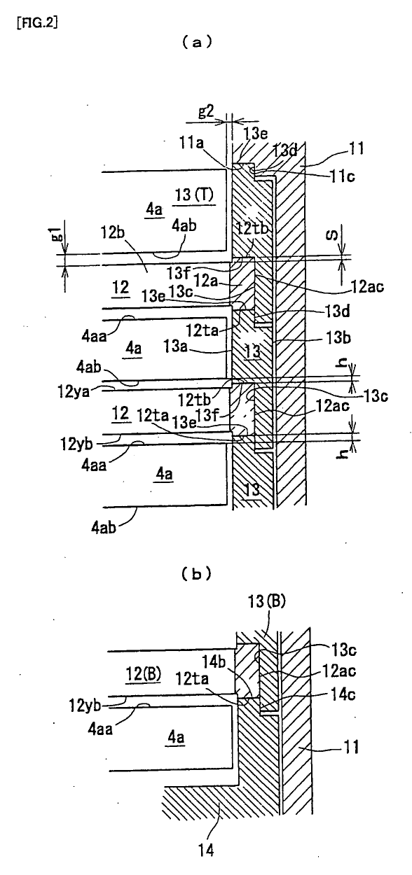

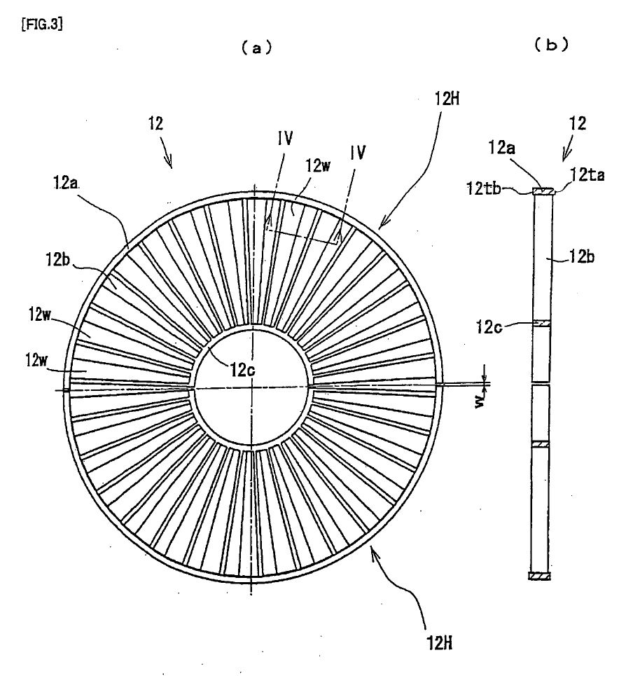

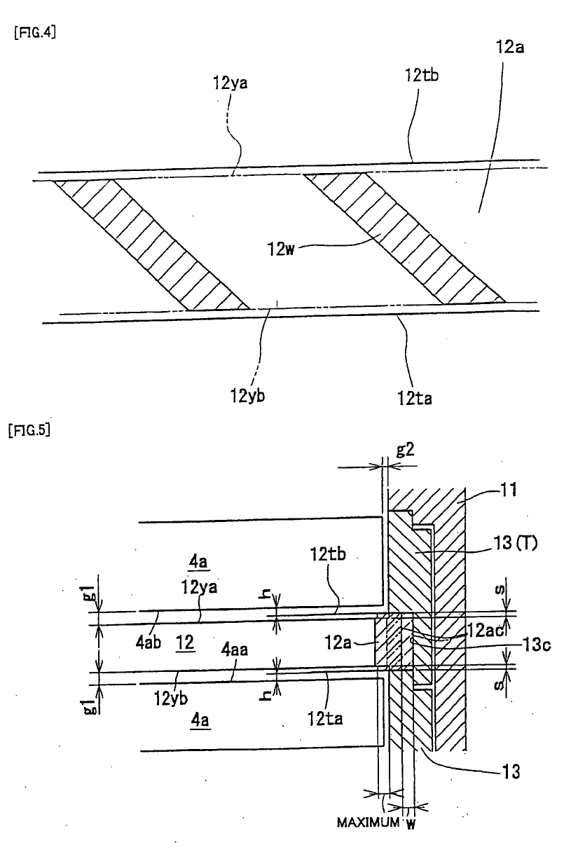

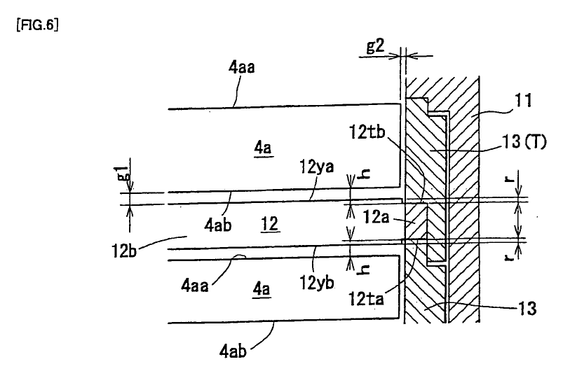

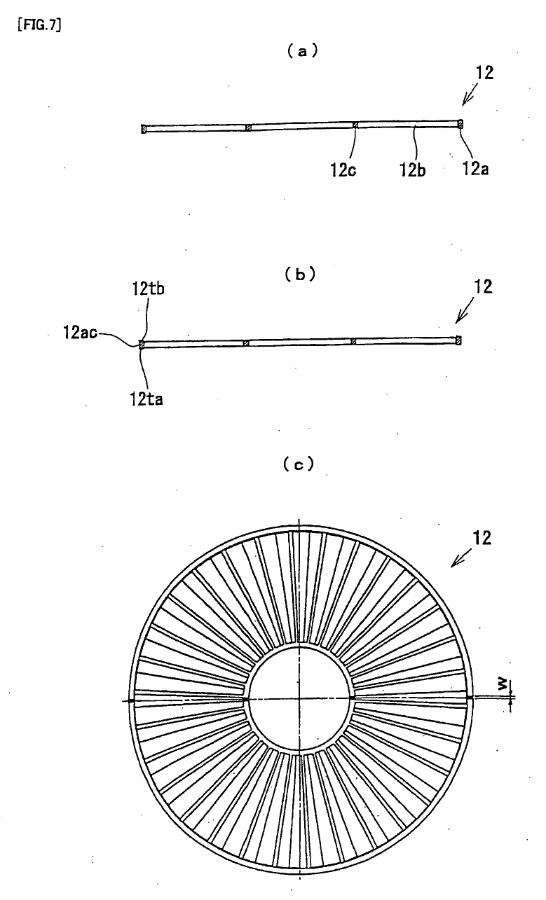

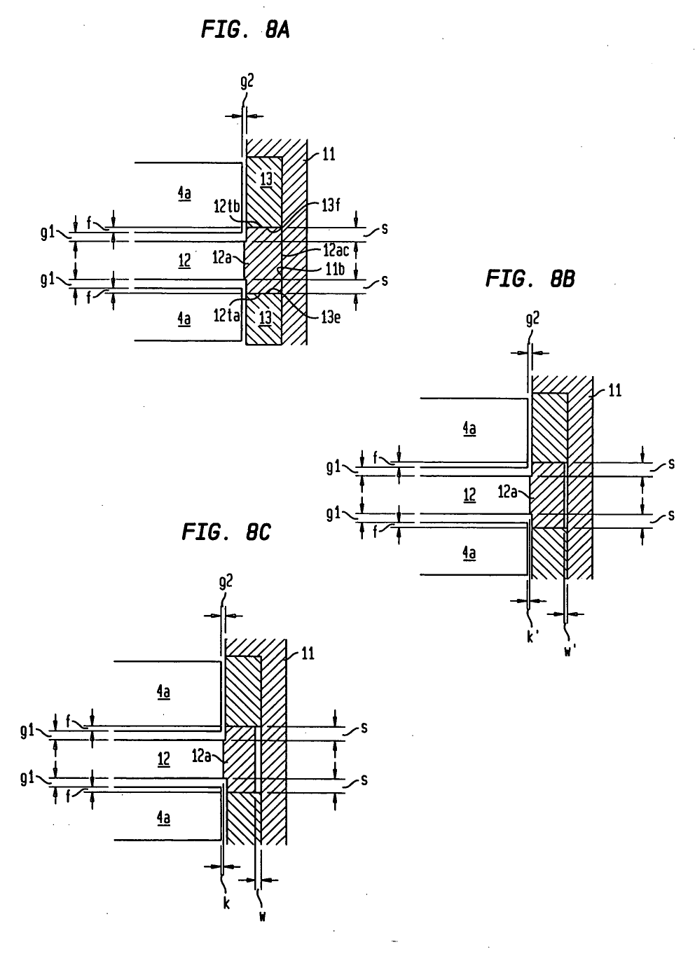

### DESCRIPTION OF SYMBOLS

1 Base
1a Socket for receiving column
2 Stator column
3 Rotor shaft
4 Rotor
4a Rotor blade wheel
4aa, 4ab rotor-blade end face
4b Skirt part
5 Radial magnetic bearing
6 Axial magnetic bearing
7 Motor
8 Bottom lid
11 Pump case
11a Spacer-abutment end face
11c Spacer-abutment cylindrical face
12 Stator blade wheel
12a Outer ring part
12ta, 12tb Base end face
12ac Outer circumferential face of outer ring part
12b Blade part
12ya, 12yb Blade-part end face of stator blade wheel
12c Inner ring part
12w Blade of stator blade wheel
12H Semicircular annular stator blade wheel
12(B) Bottommost stator blade wheel
13 Ring spacer
13a Inner cylindrical face
13b Outer cylindrical face
13c 2^{nd} inner cylindrical face
13d Stepped outer cylindrical part
13e Upper cylinder-abutment end face
13f Middle cylinder-abutment end face
13(B) Bottommost ring spacer
13(T) Topmost ring spacer
14 Screw stator
14a Screw groove
14b Stator blade wheel abutment end face
14c Spacer-abutment cylindrical face
15 Suction port
16 Exhaust port
18 Protective bearing
19 Bolt
g1 Axis line direction gap between stator blade wheel 12 and rotor blade wheel 4a
g2 Radial gap between rotor blade wheel 4a of rotor 4 and ring spacer 13
h Distance between a base end face 12ta (12tb) of outer ring part 12a and the corresponding rotor-blade end face 4aa (4ab).
s Level difference between blade-part end face 12ya (12yb) of stator blade wheel and base end face 12tb (12ta)
w cutting width
r Amount of depression of base end face 12ta (12tb) from blade-part end face of stator blade wheel 12yb (12ya)

1. A vacuum pump, comprising
a cylindrical pump case,
a rotor rotatably provided within a cylinder of the pump case,
a plurality of rotor blade wheels formed in a multi-stage manner on an outer circumference of the rotor,
a plurality of stator blade wheels provided within the cylinder of the pump case and arranged alternately with the rotor blade wheels in a multi-stage manner with a prescribed gap from the rotor blade wheels, and
a plurality of ring spacers that are provided within the cylinder of the pump case and are each interposed between the stator blade wheels,
wherein each of the rotor blade wheels is provided with upper and lower rotor-blade end faces, each of the stator blade wheels consists of a pair of cut-off half-annular stator blade wheels and has a blade part and an outer ring part, the blade part is provided with upper and lower stator-blade end faces, each of which facing to a corresponding one of the rotor-blade end faces, the outer ring part is provided with upper and lower base end faces, each of which abutting against a corresponding one of cylindrical abutment end faces of the ring spacers,
characterized in that the distance between the base end face of the outer ring part and a supposed plane which includes the corresponding rotor-blade end face is set at a value larger than the range of deformation of the rotor blade wheel during pump operation.

2. The turbo-molecular pump according to claim 1, wherein the base end face of the outer ring part projects from the blade-part end face of the stator blade wheel.

3. A method of manufacturing a stator blade wheel of a vacuum pump, comprising
a stator-blade-wheel formation step of forming an annular stator blade wheel having a blade part and an outer ring part,
a base end face finishing step of forming a base end face on an end face of the outer ring part, and setting the distance between the base end face of the outer ring part and a supposed plane including the rotor-blade end face corresponding to the base end face at a value larger than the range of deformation of the rotor blade wheel during pump operation when the base end face abuts against a cylinder-abutment end face of a ring spacer of a vacuum pump, and
a semiannular shape machining/cutting step of cutting off the stator blade wheel, on which the base end face is formed, into a semiannular shape by machining.
